(19) United States
(12) Patent Application Publication
(10) Pub. No.: US 2024/0227519 A9
(43) Pub. Date: Jul. 11, 2024

(54) OPENING-AND-CLOSING BODY DRIVING DEVICE

(71) Applicant: AISIN CORPORATION, Kariya (JP)

(72) Inventors: Masahiro TAKEZAKI, Kariya-shi (JP); Takashi HATTORI, Kariya-shi (JP); Masanobu NISHIMOTO, Kariya-shi (JP); Junji YAMAGUCHI, Kariya-shi (JP); Kimihide KATO, Kariya-shi (JP)

(73) Assignee: AISIN CORPORATION, Kariya (JP)

(21) Appl. No.: 18/482,088

(22) Filed: Oct. 6, 2023

(30) Foreign Application Priority Data
Oct. 21, 2022 (JP) 2022-169340
Aug. 9, 2023 (JP) 2023-129787

(51) Int. Cl. B60J 5/10; E05F 15/63

(52) U.S. Cl. CPC B60J 5/106; E05F 15/63

(57) ABSTRACT

An opening-and-closing body driving device includes an extendable unit including a spindle, a nut, a rod, a bearing, and a guide tube; and a driving unit. The guide tube includes an insertion portion, and an inner tube configured to allow movement of the nut in the axial direction and restrict rotation of the nut. A surface of the bearing facing a direction opposite to an insertion direction, in which the insertion portion is inserted, is defined as a first reference surface, and a surface of the housing facing a direction opposite to the insertion direction is defined as a second reference surface. A distance from the first reference surface of the bearing to a distal end of the inner peripheral wall is longer than a distance from the second reference surface of the housing to a distal end of the outer peripheral wall in the axial direction.

### CROSS REFERENCE TO RELATED APPLICATIONS

This application is based on and claims priority under 35 U.S.C. § 119 to Japanese Patent Applications 2022-169340, filed on Oct. 21, 2022, and 2023-129787, filed on Aug. 9, 2023, and the entire content of which is incorporated herein by reference.

### TECHNICAL FIELD

This disclosure relates to an opening-and-closing body driving device.

### BACKGROUND DISCUSSION

In the related art, there has been known an opening-and-closing body driving device that opens and closes a back door by extending and contracting in a state of being coupled to both a vehicle body and the back door. An opening-and-closing body driving device described in JP 2017-101537A (Reference 1) includes an extendable unit that extends and contracts, and a driving unit that drives the extendable unit. The extendable unit and the driving unit are coupled in an axial direction.

The extendable unit includes a spindle, a nut that moves in an axial direction accompanying with rotation of the spindle, a rod that moves in the axial direction together with the nut, and a guide tube that guides movement of the nut. The driving unit includes a housing having a cylindrical shape, and a driving portion that drives the spindle in a state of being accommodated in the housing. In the extendable unit, when the spindle rotates, an inner cylinder and the nut move with respect to the guide tube in the axial direction. Thus, the opening-and-closing body driving device extends or contracts according to a rotation direction of the spindle.

In the opening-and-closing body driving device as described above, when the driving unit and the extendable unit are coupled, an output shaft of the driving portion and the spindle are coupled, and the housing and the guide tube are coupled. Therefore, it is preferable that axes of a plurality of components of the opening-and-closing body driving device coincide with each other. In other words, when the axes of the plurality of components of the opening-and-closing body driving device are deviated due to a manufacturing error or the like, the above coupling work may become complicated.

### SUMMARY

According to an aspect of this disclosure, an opening-and-closing body driving device for coupling a vehicle body having an opening and an opening-and-closing body configured to open and close the opening, and for driving the opening-and-closing body by extending and contracting in an axial direction is provided. The opening-and-closing body driving device includes: an extendable unit including a spindle extending in the axial direction, a nut configured to move in the axial direction accompanying with rotation of the spindle, a rod configured to move in the axial direction together with the nut, a bearing configured to rotatably support the spindle, and a guide tube configured to support the spindle via the bearing and guide movement of the nut; and a driving unit including a driving portion configured to drive the spindle and a housing having a cylindrical shape and configured to accommodate the driving portion, in which the guide tube includes an insertion portion configured to be inserted into the housing along the axial direction, and an inner tube configured to allow movement of the nut in the axial direction and restrict rotation of the nut, the insertion portion includes an inner peripheral wall that has a cylindrical shape and into which the bearing is fitted, and an outer peripheral wall that has a cylindrical shape and that is fitted into an end portion of the housing, and when a direction in which the insertion portion is inserted into the housing is defined as an insertion direction, a surface of the bearing facing a direction opposite to the insertion direction is defined as a first reference surface, and a surface of the housing facing a direction opposite to the insertion direction is defined as a second reference surface, a distance from the first reference surface of the bearing to a distal end of the inner peripheral wall is longer than a distance from the second reference surface of the housing to a distal end of the outer peripheral wall in the axial direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle including an opening-and-closing body driving device;

FIG. 2 is a perspective view of the opening-and-closing body driving device;

FIG. 3 is an exploded perspective view of the opening-and-closing body driving device;

FIG. 4 is a cross-sectional view of a driving unit of the opening-and-closing body driving device;

FIG. 5 is a cross-sectional view of the driving unit;

FIG. 6 is a cross-sectional view of an extendable unit of the opening-and-closing body driving device;

FIG. 7 is a cross-sectional view of the extendable unit;

FIG. 8 is a cross-sectional view of a guide tube of the extendable unit;

FIG. 9 is a cross-sectional view of the extendable unit;

FIG. 10 is a cross-sectional view showing a manufacturing process of the opening-and-closing body driving device;

FIG. 11 is a cross-sectional view showing a manufacturing process of the opening-and-closing body driving device;

FIG. 12 is a cross-sectional view showing a manufacturing process of the opening-and-closing body driving device; and

FIG. 13 is a cross-sectional view showing a manufacturing process of the opening-and-closing body driving device.

### DETAILED DESCRIPTION

Hereinafter, an embodiment of a vehicle including an opening-and-closing body driving device (hereinafter, also referred to as a “door driving device”) will be described.

### Configuration of Present Embodiment

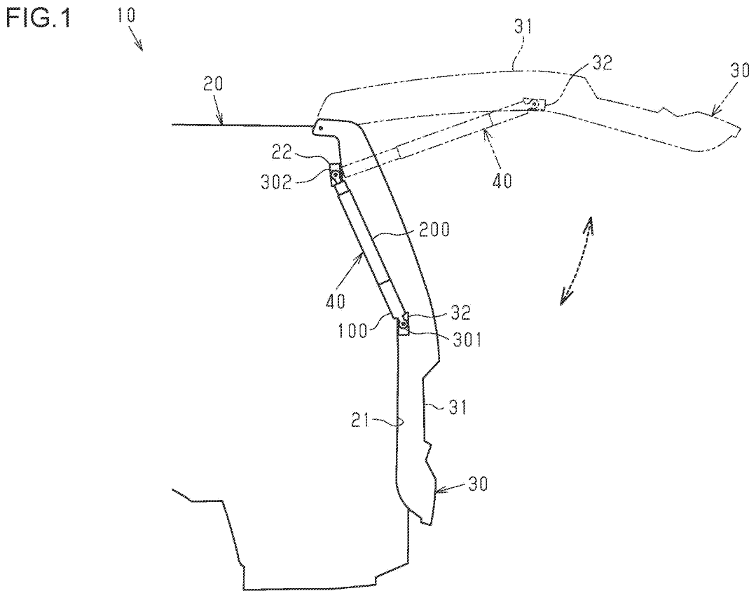

As shown in FIG. 1, a vehicle 10 includes a vehicle body 20, a back door 30, and a door driving device 40. In the following description, a width direction of the vehicle 10, a front-rear direction of the vehicle 10, and an upper-lower direction of the vehicle 10 are simply referred to as “a width direction, a front-rear direction, and an upper-lower direction”.

### Vehicle Body 20

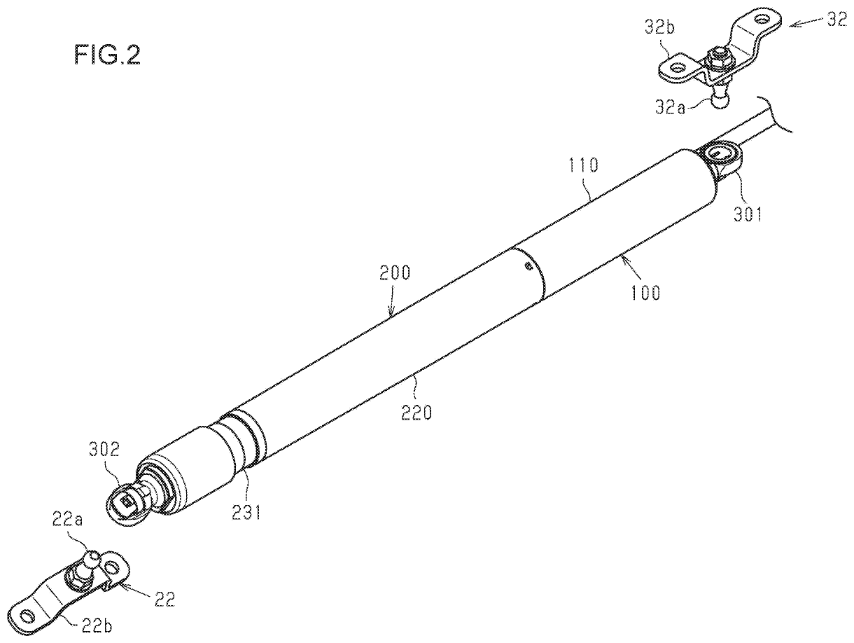

The vehicle body 20 includes a door opening 21 and two ball studs 22. The door opening 21 opens to a rear of the vehicle body 20. The door opening 21 has, for example, a rectangular shape whose longitudinal direction is the width direction and whose short direction is the upper-lower direction. The door opening 21 corresponds to an “opening”. The two ball studs 22 are provided on both sides of the door opening 21 in the width direction. Specifically, the two ball studs 22 are provided at positions slightly deviated in the width direction from a right edge and a left edge of the door opening 21 and closer to an upper edge of the door opening 21 than to a lower edge of the door opening 21. As shown in FIG. 2, the ball stud 22 includes a ball 22a that constitutes a ball joint together with a ball socket 302 to be described later, and a bracket 22b that is a fixing portion to the vehicle body 20.

### Back Door 30

As shown in FIG. 1, the back door 30 includes a door body 31 and two ball studs 32. The door body 31 has a shape corresponding to the door opening 21. A base end portion of the door body 31 is supported on the vehicle body 20 via a hinge or the like so as to be rotatable around a rotation axis extending in the width direction. The back door 30 corresponds to an “opening-and-closing body”.

The two ball studs 32 are provided on both sides of the door body 31 in the width direction. Specifically, the two ball studs 32 are fixed at positions slightly deviated from a right edge and a left edge of the door body 31 in the width direction and between a base end and a distal end of the door body 31. As shown in FIG. 2, the ball stud 32 includes a ball 32a that constitutes a ball joint together with a ball socket 301 to be described later, and a bracket 32b that is a fixing portion to the door body 31.

The back door 30 is displaced, by rotating around the rotation axis, between a fully open position where the door opening 21 is fully opened and a fully closed position where the door opening 21 is fully closed. In FIG. 1, the fully open position of the back door 30 is indicated by a two-dot chain line, and the fully closed position of the back door 30 is indicated by a solid line. In the following description, a direction in which the back door 30 moves from the fully closed position to the fully open position is referred to as an “opening direction”, and a direction in which the back door 30 moves from the fully open position to the fully closed position is referred to as a “closing direction”.

### Door Driving Device 40

Two door driving devices 40 can be mounted on the vehicle 10, or one door driving device 40 can be mounted on the vehicle 10. In a former case, the two door driving devices 40 preferably couple the vehicle body 20 and the back door 30 on both sides in the width direction. In a latter case, the door driving device 40 preferably couples the vehicle body 20 and the back door 30 on one side in the width direction. Further, in the latter case, the vehicle 10 preferably includes a gas spring that couples the vehicle body 20 and the back door 30 on the other side in the width direction.

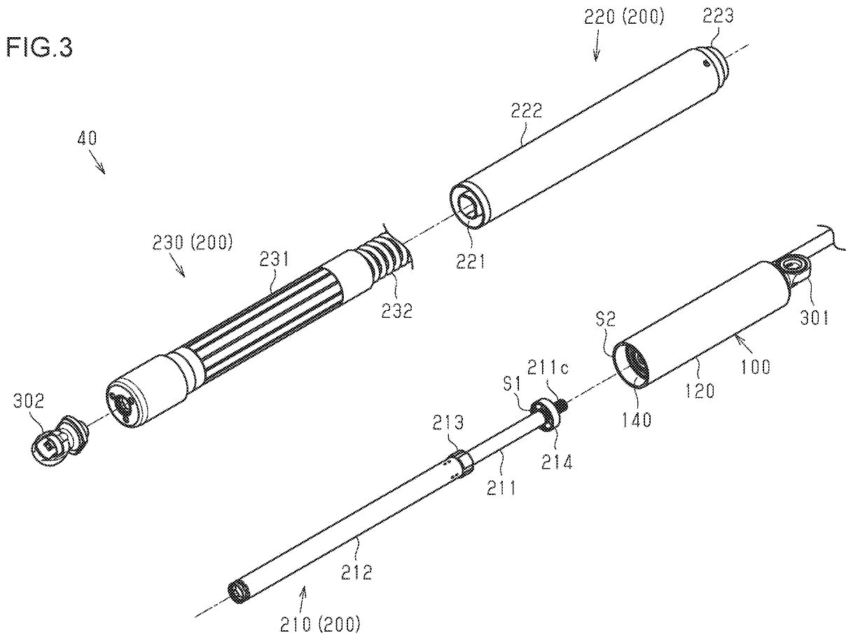

As shown in FIGS. 2 and 3, the door driving device 40 includes a driving unit 100, an extendable unit 200, and two ball sockets 301 and 302. Since the door driving device 40 according to the present embodiment is a long shaft-shaped member, in the following description, a longitudinal direction of the door driving device 40 is referred to as an “axial direction”, and a direction orthogonal to the axial direction is referred to as a “radial direction”.

Most of components of the door driving device 40 have the axial direction as the longitudinal direction. Therefore, regarding the components of the door driving device 40, an end closer to the ball socket 301 than to the ball socket 302 in the axial direction is referred to as a “first end”, and an end closer to the ball socket 302 than to the ball socket 301 in the axial direction is referred to as a “second end”.

### Driving Unit 100

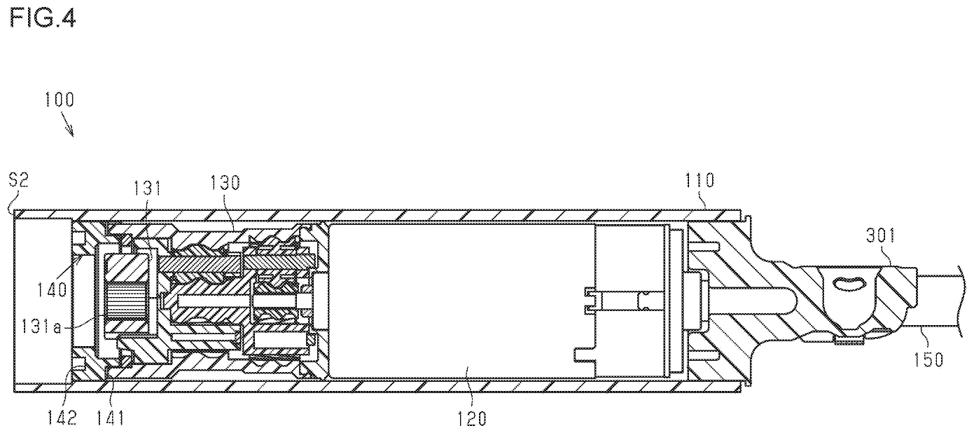

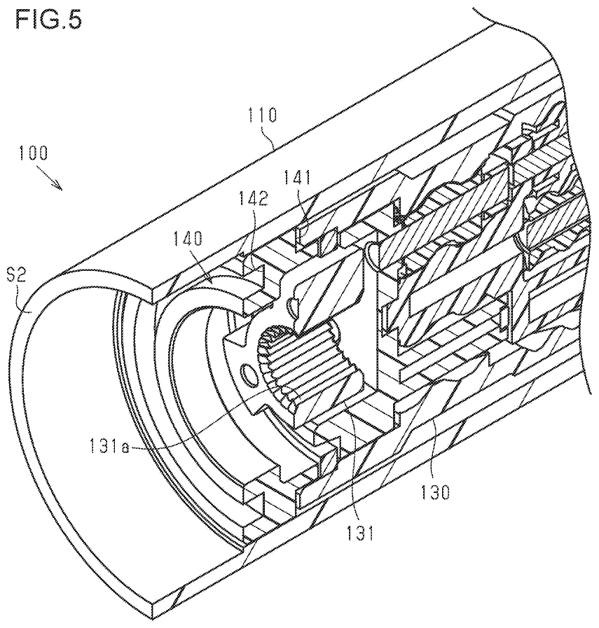

As shown in FIGS. 4 and 5, the driving unit 100 includes a housing 110, an electric motor 120, a power transmission mechanism 130, a fixture 140, and a cable 150. The electric motor 120 and the power transmission mechanism 130 constitute a “driving portion”.

The housing 110 has a cylindrical shape. The housing 110 is formed of a light transmissive resin. The light transmissive resin may be a resin material having a transmittance of 20% or more for a wavelength of laser light used for laser welding. For example, the wavelength of the laser light used for the laser welding is about 800 nm to 1200 nm. In the following description, one of two end surfaces intersecting an axial direction of the housing 110 is referred to as a second reference surface S2.

The power transmission mechanism 130 increases output torque of the electric motor 120 and transmits the output torque to the extendable unit 200. The power transmission mechanism 130 includes an output shaft 131 connected to the extendable unit 200. The output shaft 131 has a shaft hole 131a penetrating therethrough in the axial direction. The shaft hole 131a of the output shaft 131 is formed with a plurality of grooves extending in an axial direction and adjacent to each other in a circumferential direction. In other words, a serration is provided on an inner surface of the shaft hole 131a of the output shaft 131. In the present embodiment, the power transmission mechanism 130 is a so-called planetary gear mechanism. Therefore, the power transmission mechanism 130 and the electric motor 120 are adjacent to each other in the axial direction. Further, a rotation axis of a rotor of the electric motor 120 and a rotation axis of the output shaft 131 of the power transmission mechanism 130 are located on the same straight line.

The fixture 140 has a ring shape. The fixture 140 has a first engaging groove 141 formed on a first end surface and a second engaging groove 142 formed on a second end surface of both end surfaces in the axial direction. The first engaging groove 141 is a groove that engages with the power transmission mechanism 130, and the second engaging groove 142 is a groove that engages with a guide tube 220 of the extendable unit 200 to be described later. Shapes of the first engaging groove 141 and the second engaging groove 142 can be appropriately changed according to a shape of an engaging target. The fixture 140 may be formed of a light absorbing resin. The light absorbing resin may have a higher absorptivity than the above-described light transmissive resin for the wavelength of the laser light used for the laser welding.

The cable 150 is an electric wire and a signal line for supplying power to the electric motor 120 and transmitting and receiving a control signal for controlling the electric motor 120. The cable 150 is connected to a battery and a door control device that are mounted on the vehicle 10.

The housing 110 accommodates the electric motor 120, the power transmission mechanism 130, and the fixture 140. The fixture 140 is fixed to the housing 110. When the fixture 140 is made of a light transmissive resin, the housing 110 and the fixture 140 can be joined by the laser welding. The first engaging groove 141 of the fixture 140 is engaged with the power transmission mechanism 130, whereby the fixture 140 and the power transmission mechanism 130 are integrated. Thus, the electric motor 120 and the power transmission mechanism 130 are fixed to the housing 110. The ball socket 301 is press-fitted into a first end of the housing 110. When the door driving device 40 is mounted on the vehicle 10, the ball socket 301 is coupled to the ball stud 32 of the back door 30. Thus, the ball socket 301 constitutes a ball joint together with the ball stud 32 of the back door 30.

### Extendable Unit 200

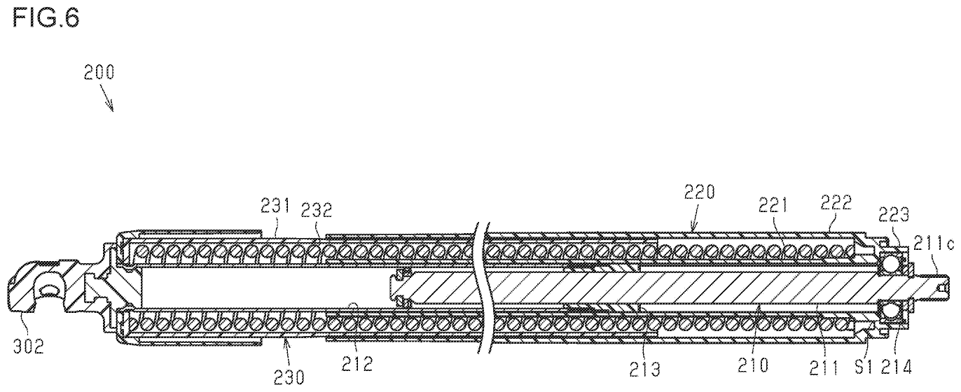

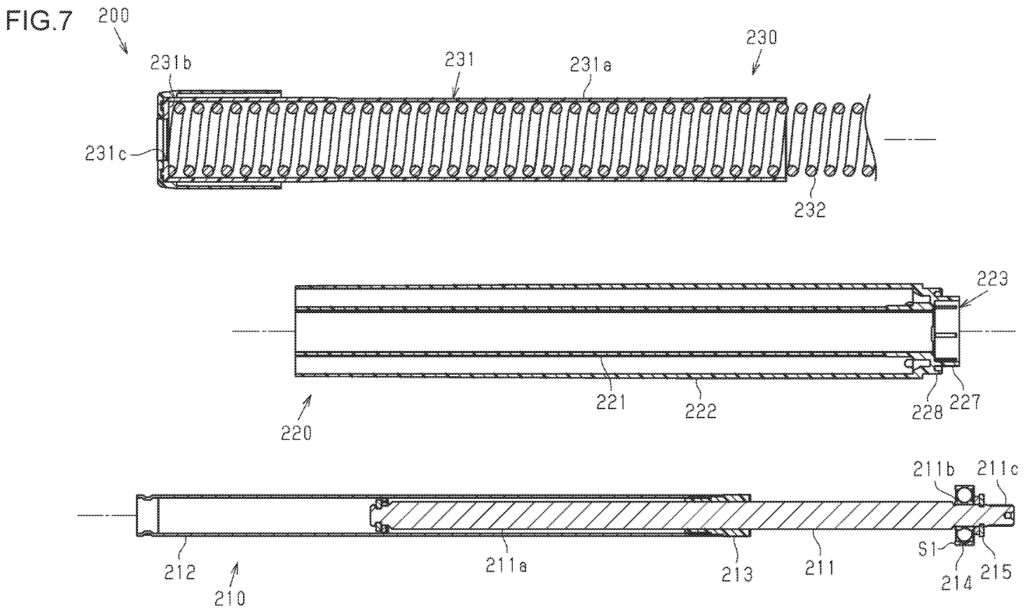

As shown in FIGS. 6 and 7, the extendable unit 200 includes a spindle mechanism 210, the guide tube 220, and a biasing mechanism 230.

### Spindle Mechanism 210

The spindle mechanism 210 includes a spindle 211, a rod 212, a nut 213, a bearing 214, and a retaining ring 215.

The spindle 211 has a columnar shape. The spindle 211 includes a screw shaft 211a, a holding shaft 211b, and a coupling shaft 211c. The screw shaft 211a occupies most of the spindle 211 in an axial direction. A screw groove is formed on a surface of the screw shaft 211a. The holding shaft 211b is located between the screw shaft 211a and the coupling shaft 211c. An outer diameter of the holding shaft 211b is smaller than an outer diameter of the screw shaft 211a. A plurality of teeth adjacent to each other in a circumferential direction and extending in an axial direction are provided on a surface of the coupling shaft 211c. In other words, a serration is provided on the surface of the coupling shaft 211c. The coupling shaft 211c is a portion coupled to the output shaft 131 of the power transmission mechanism 130.

The rod 212 has a cylindrical shape. A length of the rod 212 in an axial direction is about the same as a length of the spindle 211 in the axial direction. An inner diameter of the rod 212 is larger than an outer diameter of the spindle 211. An outer surface of the nut 213 is provided with a plurality of guides extending in an axial direction and arranged in a circumferential direction. Each of the guides may have a concave shape or a convex shape. A screw groove is formed on an inner surface of the nut 213. The screw groove of the nut 213 corresponds to the screw groove of the spindle 211. The nut 213 is fixed to a first end of the rod 212. That is, when the nut 213 moves in the axial direction, the nut 213 moves together with the rod 212 in the axial direction. The spindle 211 is inserted into the rod 212 and the nut 213. At this time, the nut 213 is screwed to the spindle 211.

The bearing 214 includes an inner ring, an outer ring, balls, and a cage. The bearing 214 is, for example, a radial ball bearing. The bearing 214 is held by a holding shaft 211b of the spindle 211. In other words, the holding shaft 211b of the spindle 211 is press-fitted into the inner ring of the bearing 214. Axial movement of the inner ring of the bearing 214 with respect to the spindle 211 is restricted by the retaining ring 215. In the following description, one of two surfaces intersecting an axial direction of the bearing 214 is referred to as a first reference surface S1. Precisely, the first reference surface S1 is a surface of the outer ring of the bearing 214.

As shown in FIG. 6, the ball socket 302 is fixed to a second end of the rod 212. When the door driving device 40 is mounted on the vehicle 10, the ball socket 302 is coupled to the ball stud 22 of the vehicle body 20. Thus, the ball socket 302 constitutes a ball joint together with the ball stud 22 of the vehicle body 20.

### Guide Tube 220

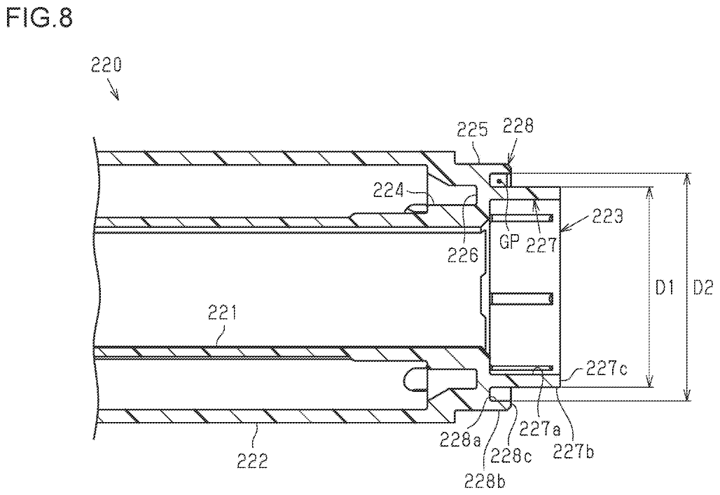

As shown in FIGS. 7 and 8, the guide tube 220 includes an inner tube 221, an outer tube 222, and an insertion portion 223. In the present embodiment, the guide tube 220 is a resin molded product made of a resin material. That is, the inner tube 221 and the outer tube 222 are integrally formed with the insertion portion 223. The guide tube 220 is formed of a light absorbing resin. The light absorbing resin may have a higher absorptivity than the above-described light transmissive resin for the wavelength of the laser light used for the laser welding.

The inner tube 221 has a cylindrical shape. An inner surface of the inner tube 221 is provided with a plurality of guides extending in an axial direction and arranged in a circumferential direction. Each of the guides of the inner tube 221 has a shape corresponding to the guide of the nut 213. For example, when the guide of the nut 213 has a concave shape, the guide of the inner tube 221 preferably has a convex shape, and when the guide of the nut 213 has a convex shape, the guide of the inner tube 221 preferably has a concave shape. The outer tube 222 has a cylindrical shape. An inner diameter of the outer tube 222 is larger than an outer diameter of the inner tube 221. Therefore, a space that accommodates a coil spring 232 to be described later is present between the outer tube 222 and the inner tube 221.

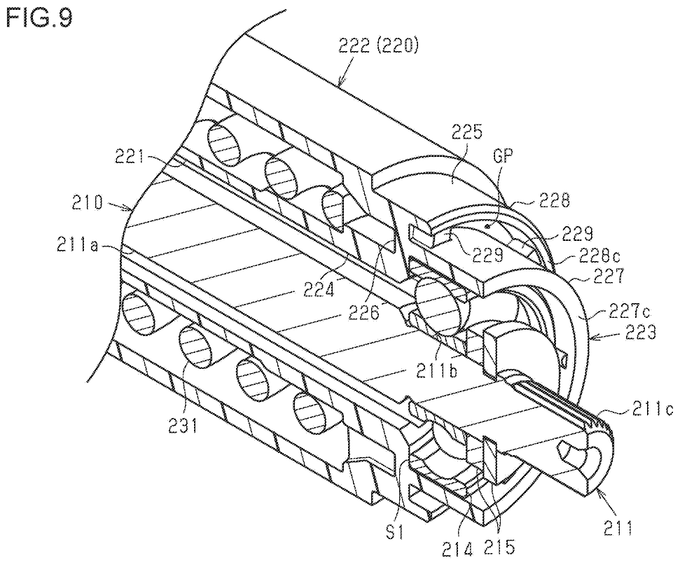

As shown in FIGS. 8 and 9, the insertion portion 223 is a portion inserted into the housing 110 of the driving unit 100. The insertion portion 223 includes an inner extension wall 224, an outer extension wall 225, a connection wall 226, an inner peripheral wall 227, an outer peripheral wall 228, and a plurality of reinforcing ribs 229.

The inner extension wall 224 and the outer extension wall 225 have a cylindrical shape. The inner extension wall 224 extends from a first end of the inner tube 221 in the axial direction. An inner diameter of the inner extension wall 224 is equal to an inner diameter of the inner tube 221. The outer extension wall 225 extends from a first end of the outer tube 222 in the axial direction. An outer diameter of the outer extension wall 225 is smaller than an outer diameter of the outer tube 222. Therefore, a step is generated between the outer extension wall 225 and the outer tube 222. The connection wall 226 has a disk shape in which a circular hole penetrates through a central portion. The connection wall 226 connects the inner extension wall 224 and the outer extension wall 225 in the radial direction.

The inner peripheral wall 227 and the outer peripheral wall 228 have a cylindrical shape. The inner peripheral wall 227 and the outer peripheral wall 228 extend from the connection wall 226 in the axial direction. The inner peripheral wall 227 includes an inner peripheral surface 227a which is an inner surface in a radial direction, an outer peripheral surface 227b which is an outer surface in the radial direction, and a distal end surface 227c which is a distal end in a protruding direction. Similarly, the outer peripheral wall 228 includes an inner peripheral surface 228a which is an inner surface in a radial direction, an outer peripheral surface 228b which is an outer surface in the radial direction, and a distal end surface 228c which is a distal end in a protruding direction.

An outer diameter D1 of the inner peripheral wall 227 is smaller than an inner diameter D2 of the outer peripheral wall 228. Therefore, a gap GP is present between the inner peripheral wall 227 and the outer peripheral wall 228. Specifically, a cylindrical gap GP is present between the outer peripheral surface 227b of the inner peripheral wall 227 and the inner peripheral surface 228a of the outer peripheral wall 228. In the axial direction, a length of the inner peripheral wall 227 is larger than a length of the outer peripheral wall 228. An outer diameter of the outer peripheral wall 228 is equal to the outer diameter of the outer extension wall 225. As shown in FIG. 9, the plurality of reinforcing ribs 229 connect the inner peripheral wall 227 and the outer peripheral wall 228 in the radial direction. Specifically, the plurality of reinforcing ribs 229 connect the outer peripheral surface 227b of the inner peripheral wall 227 and the inner peripheral surface 228a of the outer peripheral wall 228. The plurality of reinforcing ribs 229 are disposed at equal intervals in a circumferential direction. In the axial direction, a length of the reinforcing rib 229 based on the connection wall 226 is less than the length of the outer peripheral wall 228.

As shown in FIGS. 6 and 9, the spindle mechanism 210 is inserted into the guide tube 220. Specifically, the spindle 211, the rod 212, and the nut 213 are inserted into the inner tube 221. At this time, in the radial direction, a gap is present between the inner tube 221 of the guide tube 220 and the rod 212 and between the inner tube 221 of the guide tube 220 and the spindle 211. On the other hand, in the radial direction, the inner tube 221 of the guide tube 220 and the nut 213 are in contact with each other. Specifically, the guide of the inner tube 221 of the guide tube 220 and the guide of the nut 213 are engaged with each other. Thus, the nut 213 is allowed to move with respect to the guide tube 220 in the axial direction, but is restricted from rotating with respect to the guide tube 220. The bearing 214 is held by the inner peripheral wall 227. At this time, the outer ring of the bearing 214 is press-fitted into the inner peripheral wall 227.

Thus, the spindle 211 is rotatable with respect to the guide tube 220. When the spindle 211 rotates, since the nut 213 is engaged with the inner tube 221 of the guide tube 220, the nut 213 cannot rotate integrally with the spindle 211. Therefore, when the spindle 211 rotates, the nut 213 moves together with the rod 212 in the axial direction according to a rotation direction of the spindle 211. That is, the extendable unit 200 extends and contracts in the axial direction. In this regard, the spindle mechanism 210 is a mechanism for converting rotational motion of the spindle 211 into linear motion of the rod 212.

### Biasing Mechanism 230

As shown in FIG. 7, the biasing mechanism 230 includes a sliding tube 231 and the coil spring 232. The sliding tube 231 includes a cylindrical peripheral wall 231a and a disk-shaped bottom wall 231b. An outer diameter of the peripheral wall 231a is slightly smaller than the inner diameter of the outer tube 222 of the guide tube 220 and larger than the outer diameter of the inner tube 221 of the guide tube 220. The bottom wall 231b is located at a second end of the peripheral wall 231a. The bottom wall 231b has a penetration hole 231c in a central portion thereof.

As shown in FIG. 6, the sliding tube 231 is inserted between the inner tube 221 and the outer tube 222 of the guide tube 220. The coil spring 232 is disposed between the bottom wall 231b and the connection wall 226 in the axial direction and between the peripheral wall 231a or the outer tube 222 and the inner tube 221 in the radial direction. At this time, the coil spring 232 is compressed to be shorter than a natural length. Therefore, the coil spring 232 biases the sliding tube 231 in a direction in which the sliding tube 231 extends with respect to the guide tube 220. Further, a compression degree of the coil spring 232 is set to such a compression degree that the sliding tube 231 can be biased even in a state where the extendable unit 200 is most extended.

The above-described ball socket 302 is fixed to the second end of the rod 212 through the penetration hole 231c of the bottom wall 231b of the sliding tube 231. Here, the bottom wall 231b of the sliding tube 231 is not fixed to the ball socket 302. Therefore, when the spindle mechanism 210 contracts, the ball socket 302 presses the sliding tube 231, so that the coil spring 232 is compressed. On the other hand, when the spindle mechanism 210 extends, restoring force of the coil spring 232 acts on the sliding tube 231, so that the sliding tube 231 is displaced in a manner of following the ball socket 302.

### Operation of Present Embodiment

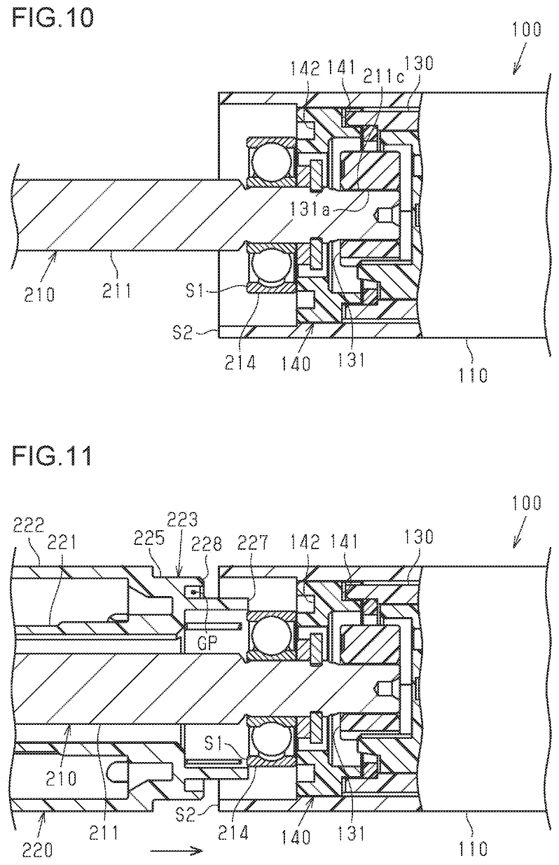

A method for manufacturing the door driving device 40 will be described with reference to FIGS. 10 to 13.

When the door driving device 40 is assembled, the driving unit 100, the spindle mechanism 210, the guide tube 220, the sliding tube 231, the coil spring 232, and the ball sockets 301 and 302 are individually prepared.

The method for manufacturing the door driving device 40 includes a first assembling process of assembling the spindle mechanism 210, a second assembling process of assembling the guide tube 220, and a third assembling process of assembling the biasing mechanism 230.

As shown in FIG. 10, the first assembling process is a process of assembling the spindle mechanism 210 to the driving unit 100. In the first assembling process, the spindle 211 of the spindle mechanism 210 is coupled to the output shaft 131 of the driving unit 100. Specifically, the coupling shaft 211c of the spindle 211 is inserted into the shaft hole 131a of the output shaft 131 of the driving unit 100, so that the serration of the output shaft 131 and the serration of the coupling shaft 211c mesh with each other. Thus, the output shaft 131 of the driving unit 100 and the spindle 211 are integrally rotatable. When the first assembling process is completed, in the axial direction, the bearing 214 of the spindle mechanism 210 comes into contact with the fixture 140 of the driving unit 100.

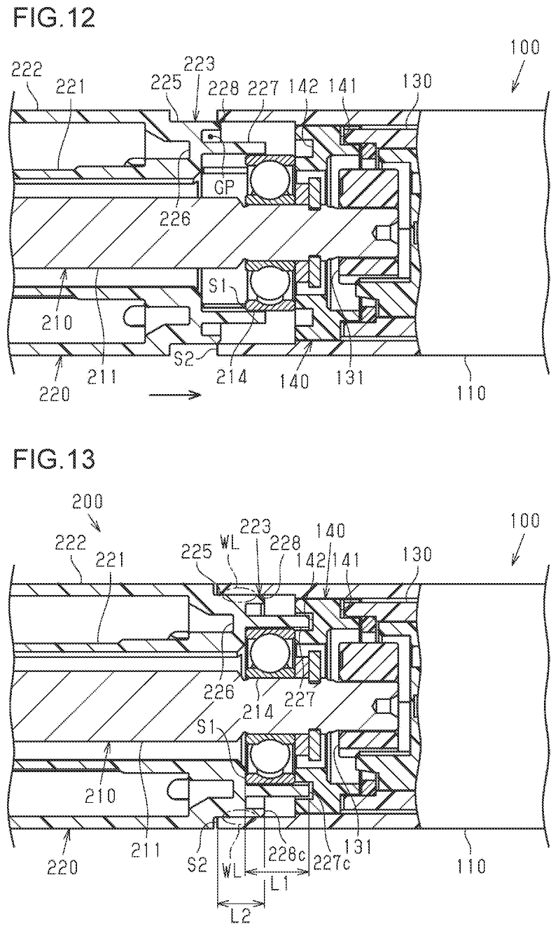

As shown in FIGS. 11 to 13, the second assembling process is a process of assembling the guide tube 220 to an integrated object of the driving unit 100 and the spindle mechanism 210. In the second assembling process, the spindle mechanism 210 extending from the driving unit 100 is inserted into the guide tube 220. The guide tube 220 is coupled to an end portion of the housing 110 of the driving unit 100. In FIGS. 11 and 12, an insertion direction of the insertion portion 223 of the guide tube 220 with respect to the housing 110 is indicated by a solid arrow. Here, the first reference surface S1 of the bearing 214 and the second reference surface S2 of the housing 110 are both surfaces facing a direction opposite to the insertion direction.

As shown in FIG. 11, when the guide tube 220 is coupled to the housing 110, first, the inner peripheral wall 227 of the insertion portion 223 of the guide tube 220 comes into contact with the outer ring of the bearing 214 of the spindle mechanism 210. In other words, at a timing at which the inner peripheral wall 227 of the guide tube 220 comes into contact with the bearing 214 of the spindle mechanism 210, a gap is formed between the outer peripheral wall 228 of the guide tube 220 and the housing 110 in the axial direction.

As shown in FIG. 12, when movement of the guide tube 220 toward the housing 110 is continued even after the inner peripheral wall 227 of the guide tube 220 comes into contact with the bearing 214 of the spindle mechanism 210, the outer ring of the bearing 214 starts to be press-fitted into the inner peripheral wall 227 of the insertion portion 223. When the press-fitting of the bearing 214 into the inner peripheral wall 227 progresses, the outer peripheral wall 228 of the guide tube 220 comes into contact with the housing 110. In other words, the outer peripheral wall 228 of the guide tube 220 starts to come into contact with the housing 110 after positioning of the inner peripheral wall 227 of the guide tube 220 and the bearing 214 in the radial direction is completed. After the outer peripheral wall 228 of the guide tube 220 comes into contact with the housing 110, the outer peripheral wall 228 of the guide tube 220 and the outer extension wall 225 are press-fitted into the housing 110 accompanying with movement of the guide tube 220.

As shown in FIG. 13, when the movement of the guide tube 220 toward the housing 110 is further continued, the outer ring of the bearing 214 comes into contact with the connection wall 226 of the insertion portion 223. That is, the press-fitting of the outer ring of the bearing 214 to the inner peripheral wall 227 is completed, and the press-fitting of the outer peripheral wall 228 and the outer extension wall 225 to the housing 110 is completed. Further, a distal end portion of the inner peripheral wall 227 is accommodated in the second engaging groove 142 of the fixture 140.

As shown in FIG. 13, in the present embodiment, in the axial direction, a distance L1 from the first reference surface S1 of the bearing 214 to the distal end surface 227c of the inner peripheral wall 227 is longer than a distance L2 from the second reference surface S2 of the housing 110 to the distal end surface 228c of the outer peripheral wall 228. Therefore, in the second assembling process, a timing at which the inner peripheral wall 227 comes into contact with the bearing 214 is earlier than a timing at which the outer peripheral wall 228 comes into contact with the housing 110. The above distance L1 is also a distance in which the guide tube 220 moves relative to the housing 110 from start of insertion of the bearing 214 into the inner peripheral wall 227 to completion of the insertion. Similarly, the above distance L2 is also a distance in which the guide tube 220 moves relative to the housing 110 from start of insertion of the outer peripheral wall 228 into the housing 110 to completion of the insertion.

In the present embodiment, in order to increase joining strength between the housing 110 and the guide tube 220, the housing 110 and the guide tube 220 are laser-welded. Specifically, a portion surrounded by a one-dot chain line in FIG. 13, that is, a portion where the housing 110 overlaps the outer peripheral wall 228 and the outer extension wall 225 of the guide tube 220 is irradiated with laser light. Then, a part of the laser light is absorbed by the guide tube 220 after passing through the housing 110, so that the guide tube 220 generates heat. As a result, the housing 110 and the guide tube 220 are welded. In other words, a welded portion WL is generated between the housing 110 and the guide tube 220.

The third assembling process is a process of assembling the biasing mechanism 230 to the guide tube 220. In the third assembling process, after coupling between the housing 110 and the guide tube 220 is completed, the coil spring 232 and the sliding tube 231 are inserted into the guide tube 220. Further, the ball socket 302 is fixed to the second end of the rod 212 of the spindle mechanism 210 protruding from the bottom wall 231b of the sliding tube 231. Thus, the door driving device 40 is completed.

### Effects of the Present Embodiment

(1) The insertion portion 223 of the guide tube 220 includes the inner peripheral wall 227 into which the bearing 214 is fitted and the outer peripheral wall 228 fitted into the housing 110. Since the outer diameter D1 of the inner peripheral wall 227 is smaller than the inner diameter D2 of the outer peripheral wall 228 in the radial direction, the gap GP is formed between the inner peripheral wall 227 and the outer peripheral wall 228. Therefore, in the radial direction, the inner peripheral wall 227 can be deformed in a manner of falling slightly toward the outer peripheral wall 228, and the outer peripheral wall 228 can be deformed in a manner of falling slightly toward the inner peripheral wall 227. As a result, even if a slight deviation occurs among an axis of the spindle 211, an axis of the guide tube 220, and an axis of the housing 110, resistance when the insertion portion 223 of the guide tube 220 is inserted into the housing 110 tends to be reduced. Specifically, due to the deviation of the above axes, press-fitting resistance when the guide tube 220 is press-fitted into the housing 110 tends to be reduced. Thus, workability is improved when the guide tube 220 is coupled to the housing 110.

(2) Since the door driving device 40 includes the coil spring 232, even when the electric motor 120 is stopped, a state where the extendable unit 200 extends is easily maintained. Therefore, the door driving device 40 can easily keep the back door 30 at a fully open position even when the electric motor 120 is stopped.

(3) The inner tube 221 and the outer tube 222 constituting the guide tube 220 and the insertion portion 223 are integrally formed of a resin material. Therefore, the door driving device 40 can reduce the number of components constituting the device.

(4) In the axial direction, the distance L1 from the first reference surface S1 of the bearing 214 to the distal end surface 227c of the inner peripheral wall 227 is longer than the distance L2 from the second reference surface S2 of the housing 110 to the distal end surface 228c of the outer peripheral wall 228. Therefore, in the second assembling process, a timing at which the bearing 214 is fitted into the inner peripheral wall 227 is earlier than a timing at which the outer peripheral wall 228 is fitted into the housing 110. Accordingly, when the door driving device 40 is manufactured, an operator can easily perform positioning of the inner peripheral wall 227 with respect to the bearing 214 and positioning of the outer peripheral wall 228 with respect to the housing 110. Therefore, the door driving device 40 can improve workability in assembling the guide tube 220.

Further, a distal end of the inner peripheral wall 227 extends with respect to a distal end of the outer peripheral wall 228 in the insertion direction. Therefore, in the second assembling process, an axis of the inner peripheral wall 227 easily coincides with an axis of the bearing 214. Accordingly, the door driving device 40 can further improve workability in assembling the guide tube 220.

(5) The housing 110 of the driving unit 100 is made of a light transmissive resin, and the guide tube 220 is made of a light absorbing resin. Therefore, the door driving device 40 can join the housing 110 and the insertion portion 223 of the guide tube 220 inserted into the housing 110 by the laser welding. Therefore, the door driving device 40 can increase joining strength between the housing 110 and the guide tube 220.

(6) The guide tube 220 includes the plurality of reinforcing ribs 229 that connect the inner peripheral wall 227 and the outer peripheral wall 228. Therefore, the door driving device 40 can prevent rigidity of the inner peripheral wall 227 and the outer peripheral wall 228 from being excessively reduced due to the gap GP between the inner peripheral wall 227 and the outer peripheral wall 228.

### Modifications

The present embodiment can be modified and implemented as follows. The present embodiment and the following modifications can be implemented in combination with each other within a technically inconsistent range.

A manufacturing order of the door driving device 40 can be appropriately modified. For example, in the method for manufacturing the door driving device 40, first, the spindle mechanism 210 may be assembled to the guide tube 220. Thereafter, in the method for manufacturing the door driving device 40, the driving unit 100 may be assembled. In this case, an effect (1) of the above embodiment can also be attained.

In the door driving device 40, the housing 110 of the driving unit 100 and the guide tube 220 of the extendable unit 200 may not be joined by the laser welding. For example, the housing 110 and the guide tube 220 may be joined by interference fit, may be joined by adhesion, or may be joined by screwing. In these cases, the housing 110 does not need to be made of a light transmissive resin.

In the door driving device 40, materials of the housing 110 of the driving unit 100 and the guide tube 220 of the extendable unit 200 may be made of the same resin material. The materials of the housing 110 of the driving unit 100 and the guide tube 220 of the extendable unit 200 may be a metal material.

In the guide tube 220, the inner tube 221 is constructed separately from the outer tube 222.

In the guide tube 220, the lengths of the inner peripheral wall 227 and the outer peripheral wall 228 extending from the connection wall 226 can be appropriately changed. For example, the outer peripheral wall 228 may extend longer than the inner peripheral wall 227.

In the guide tube 220, the inner peripheral wall 227 and the outer peripheral wall 228 may be connected to each other in the radial direction. That is, the outer diameter D1 of the inner peripheral wall 227 may be equal to the inner diameter D2 of the outer peripheral wall 228. In this case, no gap GP is present between the inner peripheral wall 227 and the outer peripheral wall 228.

In the guide tube 220, the distal end surface 227c of the inner peripheral wall 227 may be pointed. That is, the distal end surface 227c of the inner peripheral wall 227 may not have a planar shape when viewed visually. The same applies to the distal end surface 228c of the outer peripheral wall 228.

The door driving device 40 that drives the back door 30 may be an opening-and-closing body driving device that drives another opening-and-closing body of the vehicle 10. For example, the door driving device 40 may be an opening-and-closing body driving device that drives a hood panel, a fuel lid, and a swing door of the vehicle 10. Here, it is preferable that the opening-and-closing body is swingable around an axis extending in any direction.

### Aspect 1

According to an aspect of this disclosure, an opening-and-closing body driving device for coupling a vehicle body having an opening and an opening-and-closing body configured to open and close the opening, and for driving the opening-and-closing body by extending and contracting in an axial direction is provided. The opening-and-closing body driving device includes: an extendable unit including a spindle extending in the axial direction, a nut configured to move in the axial direction accompanying with rotation of the spindle, a rod configured to move in the axial direction together with the nut, a bearing configured to rotatably support the spindle, and a guide tube configured to support the spindle via the bearing and guide movement of the nut; and a driving unit including a driving portion configured to drive the spindle and a housing having a cylindrical shape and configured to accommodate the driving portion, in which the guide tube includes an insertion portion configured to be inserted into the housing along the axial direction, and an inner tube configured to allow movement of the nut in the axial direction and restrict rotation of the nut, the insertion portion includes an inner peripheral wall that has a cylindrical shape and into which the bearing is fitted, and an outer peripheral wall that has a cylindrical shape and that is fitted into an end portion of the housing, and when a direction in which the insertion portion is inserted into the housing is defined as an insertion direction, a surface of the bearing facing a direction opposite to the insertion direction is defined as a first reference surface, and a surface of the housing facing a direction opposite to the insertion direction is defined as a second reference surface, a distance from the first reference surface of the bearing to a distal end of the inner peripheral wall is longer than a distance from the second reference surface of the housing to a distal end of the outer peripheral wall in the axial direction.

For example, consider a case where, when the opening-and-closing body driving device is assembled, the guide tube is assembled after the extendable unit is assembled into the driving unit. In this case, when the guide tube is assembled, it is necessary to fit the outer peripheral wall of the insertion portion into the housing of the driving unit while fitting the bearing into the inner peripheral wall of the insertion portion. In the opening-and-closing body driving device having the above configuration, the distance from the first reference surface of the bearing to the distal end of the inner peripheral wall is longer than the distance from the second reference surface of the housing to the distal end of the outer peripheral wall. Therefore, when the guide tube is assembled, a timing at which the bearing is fitted into the inner peripheral wall is earlier than a timing at which the outer peripheral wall is fitted into the housing. Accordingly, the opening-and-closing body driving device can improve workability in assembling the guide tube in that the two timings are deviated.

### Aspect 2

In the opening-and-closing body driving device according to aspect 1, the distal end of the inner peripheral wall preferably extends with respect to the distal end of the outer peripheral wall in the insertion direction.

Since the distal end of the inner peripheral wall extends with respect to the distal end of the outer peripheral wall in the insertion direction, an axis of the inner peripheral wall easily coincides with an axis of the bearing when the guide tube is assembled. Accordingly, the opening-and-closing body driving device can further improve workability when the guide tube is assembled.

### Aspect 3

In the opening-and-closing body driving device according to aspect 1 or aspect 2, an outer diameter of the inner peripheral wall is preferably smaller than an inner diameter of the outer peripheral wall in a radial direction orthogonal to the axial direction.

The insertion portion of the guide tube includes the inner peripheral wall into which the bearing is fitted and the outer peripheral wall fitted into the housing. Since the outer diameter of the inner peripheral wall is smaller than the inner diameter of the outer peripheral wall in the radial direction, a gap is formed between the inner peripheral wall and the outer peripheral wall. Therefore, in the radial direction, the inner peripheral wall can be deformed in a manner of falling slightly toward the outer peripheral wall, and the outer peripheral wall can be deformed in a manner of falling slightly toward the inner peripheral wall. As a result, even if a slight deviation occurs among an axis of the spindle, an axis of the guide tube, and an axis of the housing, in other words, among the axis of the bearing, the axis of the guide tube, and the axis of the housing, the insertion portion of the guide tube can be inserted into the housing. Thus, workability is improved when the guide tube is coupled to the housing.

### Aspect 4

In the opening-and-closing body driving device according to any one of aspects 1 to 3, it is preferable that, the guide tube includes: an outer tube having an inner diameter larger than an outer diameter of the inner tube in a radial direction orthogonal to the axial direction; and a coil spring accommodated in a space between the inner tube and the outer tube and configured to bias the extendable unit in a direction in which the extendable unit expands, and in the guide tube, the inner tube, the outer tube, and the insertion portion are integrally formed of a resin material.

Since the opening-and-closing body driving device includes the coil spring, even when the driving portion is stopped, a state where the extendable unit extends is easily maintained. Therefore, the opening-and-closing body driving device can easily keep the opening-and-closing body at a position where the opening is opened even when the driving portion is stopped. In addition, since the inner tube and the outer tube constituting the guide tube and the insertion portion are integrally formed of the resin material, the number of components of the opening-and-closing body driving device is reduced.

### Aspect 5

In the opening-and-closing body driving device according to any one of aspects 1 to 4, it is preferable that, the outer peripheral wall of the guide tube is joined to the housing, the housing is made of a light transmissive resin, and the guide tube is made of a light absorbing resin.

The opening-and-closing body driving device can join the housing and the insertion portion of the guide tube inserted into the housing by laser welding. Therefore, the opening-and-closing body driving device can increase joining strength between the housing and the guide tube.

The opening-and-closing body driving device can improve workability when the plurality of units constituting the device are coupled.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An opening-and-closing body driving device for coupling a vehicle body having an opening and an opening-and-closing body configured to open and close the opening, and for driving the opening-and-closing body by extending and contracting in an axial direction, the opening-and-closing body driving device comprising:
an extendable unit including a spindle extending in the axial direction, a nut configured to move in the axial direction accompanying with rotation of the spindle, a rod configured to move in the axial direction together with the nut, a bearing configured to rotatably support the spindle, and a guide tube configured to support the spindle via the bearing and guide movement of the nut; and
a driving unit including a driving portion configured to drive the spindle and a housing having a cylindrical shape and configured to accommodate the driving portion, wherein
the guide tube includes an insertion portion configured to be inserted into the housing along the axial direction, and an inner tube configured to allow movement of the nut in the axial direction and restrict rotation of the nut,
the insertion portion includes an inner peripheral wall that has a cylindrical shape and into which the bearing is fitted, and an outer peripheral wall that has a cylindrical shape and that is fitted into an end portion of the housing, and
when a direction in which the insertion portion is inserted into the housing is defined as an insertion direction, a surface of the bearing facing a direction opposite to the insertion direction is defined as a first reference surface, and a surface of the housing facing a direction opposite to the insertion direction is defined as a second reference surface, a distance from the first reference surface of the bearing to a distal end of the inner peripheral wall is longer than a distance from the second reference surface of the housing to a distal end of the outer peripheral wall in the axial direction.

2. The opening-and-closing body driving device according to claim 1, wherein
in the guide tube, the distal end of the inner peripheral wall extends with respect to the distal end of the outer peripheral wall in the insertion direction.

3. The opening-and-closing body driving device according to claim 1, wherein
an outer diameter of the inner peripheral wall is smaller than an inner diameter of the outer peripheral wall in a radial direction orthogonal to the axial direction.

4. The opening-and-closing body driving device according to claim 1, wherein
the guide tube includes:
an outer tube having an inner diameter larger than an outer diameter of the inner tube in a radial direction orthogonal to the axial direction; and
a coil spring accommodated in a space between the inner tube and the outer tube and configured to bias the extendable unit in a direction in which the extendable unit expands, and
in the guide tube, the inner tube, the outer tube, and the insertion portion are integrally formed of a resin material.

5. The opening-and-closing body driving device according to claim 1, wherein
the outer peripheral wall of the guide tube is joined to the housing,
the housing is made of a light transmissive resin, and
the guide tube is made of a light absorbing resin.

6. The opening-and-closing body driving device according to claim 2, wherein
an outer diameter of the inner peripheral wall is smaller than an inner diameter of the outer peripheral wall in a radial direction orthogonal to the axial direction.

7. The opening-and-closing body driving device according to claim 2, wherein
the guide tube includes:
an outer tube having an inner diameter larger than an outer diameter of the inner tube in a radial direction orthogonal to the axial direction; and
a coil spring accommodated in a space between the inner tube and the outer tube and configured to bias the extendable unit in a direction in which the extendable unit expands, and
in the guide tube, the inner tube, the outer tube, and the insertion portion are integrally formed of a resin material.

8. The opening-and-closing body driving device according to claim 2, wherein
the outer peripheral wall of the guide tube is joined to the housing,
the housing is made of a light transmissive resin, and
the guide tube is made of a light absorbing resin.
